(19) United States
(12) Patent Application Publication
(10) Pub. No.: US 2006/0184577 A1
(43) Pub. Date: Aug. 17, 2006

(54) Methods and apparatuses to determine adult images by query association

(76) Inventors: Kaushal Kurapati, Yorktown Heights, NY (US); Rahul Lahiri, Belmont, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/132,616

(22) Filed: May 18, 2005

Related U.S. Application Data
(60) Provisional application No. 60/653,412, filed on Feb. 15, 2005.

(51) Int. Cl. G06F 17/00

(52) U.S. Cl. 707/104.1

(57) ABSTRACT

Various methods and apparatuses are described for an adult content detection implementation. In one embodiment, a method detects adult content images by tracked query association to a user's query for an image search. The set of images returned in response to the user's query on a search engine are based on whether one or more images in the set are classified as an adult content image.

### RELATED APPLICATIONS

This application claims the benefit of the following provisional patent application, application No. 60/653,412, titled “Methods and apparatuses to determine adult images by query association” that was filed on Feb. 15, 2005.

### NOTICE OF COPYRIGHT

A portion of the disclosure of this patent document contains material that is subject to copyright protection. The copyright owner has no objection to the facsimile reproduction by anyone of the software engine and its modules, as it appears in the Patent and Trademark Office Patent file or records, but otherwise reserves all copyright rights whatsoever.

### FIELD

The invention generally relates to search engines and more specifically to control over adult content material provided by that search engine.

### BACKGROUND

The Internet makes information on all subjects available to virtually any user of the Internet. Adult content information, such as pornographic images, proliferates the Internet. As such, a likelihood exists that adult content information may be returned on a user's query even if the search terms of the user's query had no obvious terms that would be soliciting such information.

Some Internet service providers allow for users to set parental controls “opt-in” filters that allow user parents to define which emails each user can receive, and limit the sites that each user can surf by providing a limited browser. Each individual user must explicitly activate and set the parental controls “opt-in” filters in order to try to prevent adult content information from being returned when their children surf the Internet. For example, America On-Line's parental controls have to be set explicitly by each user and eliminate web sites that can be visited.

An example parental controls software eliminates web sites that can be visited rather than analyzing a user's query.

### SUMMARY

Various methods and apparatuses are described for an adult content detection mechanism. In one embodiment, adult content images are detected by tracked query association to a user's query for an image search. The set of images returned in response to the user's query on a search engine are based on whether one or more images in the set are classified as an adult content image.

### BRIEF DESCRIPTION OF THE DRAWINGS

FIG. 1 is a block diagram of an embodiment of a system to return images in response to a user's query.

FIG. 2 is a flow diagram of an example adult content detection algorithm used by the search engine to eliminate one or more adult content images from the set of images that are returned in response to a user's query containing non-pornographic search terms.

### DETAILED DISCUSSION

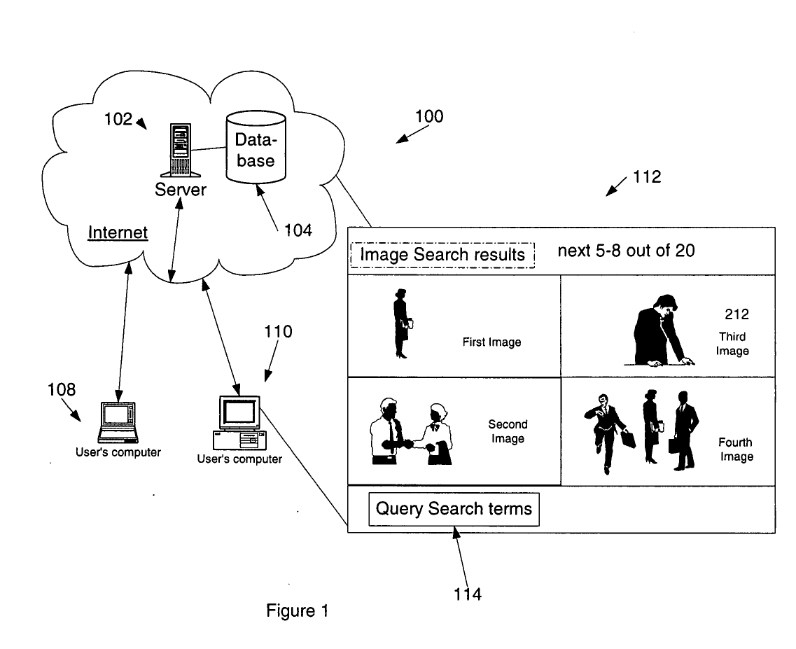

FIG. 1 illustrates a system 100 to return images in response a user's query according to an embodiment of the invention. The system 100 includes a server 102, a database 104, a network connection 106, such as the connection to the Internet, and one or more devices 108, 110 from users of a search engine provided by the server 102.

The server 102 has a search engine. The server 102 presents a web page to allow users to submit a user's query 114 to search for images relevant to search terms in the user's query 114 with the search engine. The server 102 implements an algorithm to detect adult content images by tracked query association to the user's query 114 for the image search. The adult content detection algorithm modifies a set of images 112 that are returned in response to the user's query 114 on the search engine based on whether one or more images in the set of images 112 are classified as an adult content image. The database 104 stores potential adult content information based upon at least the tracked query association information regarding one or more of the potential images in the set of images 112.

The search engine employs an adult content detection algorithm that determines adult images or other adult content by query association. The adult content detection algorithm improves a picture search by a search engine on a web page such as the Ask.com Picture Channel™. The adult content detection algorithm may drastically improve the relevancy of the picture search product.

The adult content detection algorithm acts as pornographic image detection technology. The adult content detection algorithm provides a “clean” user experience to the users of this search engine by not responding with adult images to clean queries, especially when the user is a child. Also, a company running the search engine may lose a loyal user of the search engine. The adult content detection algorithm has the advantage that it does not have to resort to any sort of image analysis, but relies merely on user behavior to implicitly determine if a particular image should be classified as an adult image.

The database 104 stores potential adult content information regarding one or more images potentially in a set of images returned in response to the user's query 114. The database 104 may keep statistical track of relevant information from all past and current user sessions. The database 104 stores and statistically tracks query associations based upon past user behavior as well as tracked characteristics of the source of the image. The database 104 stores the adult content nature of these images. The information regarding the adult content nature of images may be derived from the statistically tracked query association. A few examples of the statistically tracked query associations may be a query-to-pick correlation, a pick-to-pick correlation, a query-to-query correlation, a pick-to-query correlation, as well as other similar statistically tracked user behavior correlations.

As will be discussed more in detail later, a query to pick (Q2P) correlation may examine whether there are any terms in the query to indicate that the query is not of a clean nature and what images from those returned to a potential pornographic user's query 114 were picked during that user session. As will be discussed more in detail later, a pick-to-pick (P2P) correlation may associate all picks made during a user session with all other picks issued during that session. A user thought these images were relevant to the user's query and a correlation is established between all of the selected images picked during that session.

Thus, from time to time, for certain regular—clean—queries that do not contain search terms implying pornography, adult content images show up in the image search results anyway. The adult content detection algorithm attempts to minimize the return as adult content images because the unwanted presence of adult content creates a bad user experience. However, the task of identifying whether an image is pornographic or not is not trivial without doing image analysis, which may be very time consuming. The adult content detection algorithm envisions a way of detecting pornographic images by using at least tracked query association.

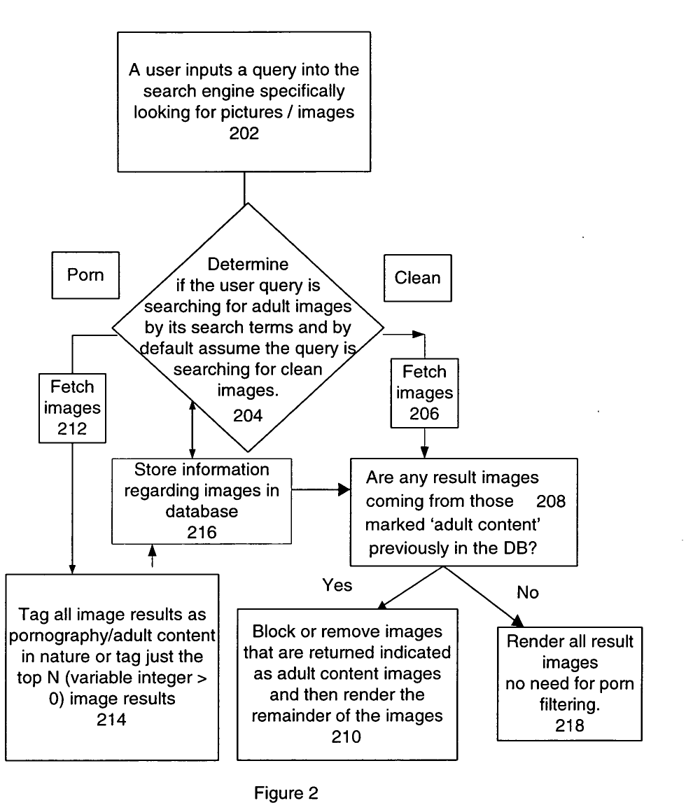

FIG. 2 illustrates an example adult content detection algorithm used by the search engine to eliminate one or more adult content images from the set of images that are returned in response to a user's query containing non-pornographic search terms. The following operations may be implemented with software instructions, hardware or firmware logic, a combination of the two, or a similar mechanism.

In block 202, a user may input search terms for a query into the search engine that specifically looks for images to return in response to that query.

In block 204, the adult content detection algorithm determines if the user's query is searching for adult images by its search terms. The adult content detection algorithm by default assumes that the user's query is searching for images non-pornographic in nature. The adult content detection algorithm may also have a list of terms that when present in the search terms classify these queries as pornographic queries. Thus, the adult content detection algorithm may analyze the search terms in the user's query to determine if the query under consideration (q_c) is classified by the system to be clean. If the system does not detect search terms that indicate the query is searching for adult content images, then by default the q_c is classified by the system to be a clean query seeking non-pornographic images.

In block 206, the adult content detection algorithm fetches the image results for the clean query. For example, if the search terms in the user's query are a person's name, the search engine displays a list of pictures relevant to that person's name.

In block 208, the adult content detection algorithm determines whether any potential images in the search results have been marked/tagged as being adult content in nature. The adult content detection algorithm compares the images returned in response to the user's query to information regarding the adult content nature of these images stored in the database. The information regarding the adult content nature of the images may be determined by the statistically tracked query association information as well as other non-image analysis tracked information. In an embodiment, the adult content detection algorithm may analyze other queries, such as q_1 . . . q_N, from session co-occurrence data that were entered by various users in various sessions along with the query under consideration (q_c). In general, queries in the same session tend to belong to a particular topic. The adult content detection algorithm checks the clean or pornographic classifications for queries numbers q_1 . . . q_N.

The algorithm may eliminate one or more adult content images from the set of images that are returned in response to the user's query through the above comparison. Thus, the algorithm knows the image results for the clean query q_c. The algorithm may compare the image results for the clean query q_c and the tracked information stored in the database about any of the previously returned images from known pornographic queries. If any images are in common, then the common images are naturally pornographic/adult content and they should not be shown in response to the user's query q_c. Commonality of images can be established by image IDs, and/or image Universal Resource Locator (URL) address.

In block 210, the adult content detection algorithm modifies the set of images that are returned in response to the user's query on a search engine web page based on whether one or more images in the set are classified as an adult content image. The adult content detection algorithm eliminates one or more images tagged as adult content images from the set of images that are returned in response to the user's query. The search engine then renders the rest of the returned images to the user's query.

In block 204, the adult content detection algorithm also determines if the query is pornographic in nature because it contains search terms that classify these queries as pornographic queries. The adult content detection algorithm may have a list of terms that when present in the search terms classify these queries as pornographic queries.

In block 212, the adult content detection algorithm fetches the image results returned in response to the query containing search terms classified as adult content. The set of images would most probably all be adult content/pornographic in nature.

In block 214, the adult content detection algorithm tags some or all of the image results returned in response to the adult content query as potentially adult content images. The adult content detection algorithm may perform a query-to-pick correlation by tagging one or more of the set of images as adult content/pornographic in nature. Images picked by the user in response to the user's query containing adult content search terms are most likely adult content in nature. Thus, every image picked to that user's query may be potentially tagged as adult content in nature. Likewise, the adult content detection algorithm may tag all the results that show up for pornographic queries, as pornographic images. Similarly, the adult content detection algorithm could keep track over time to tag only the most frequently selected images. The adult content detection algorithm could establish a threshold amount of selection occurrences that must occur before the image is tagged as adult content in nature. The adult content detection algorithm may also perform a pick-to-pick correlation to ferret out those images that are often picked in conjunction with known adult content images. Again, all associated images may be tagged or a basic threshold number of times picked can be established as criteria for tagging an image as adult content in nature.

In an embodiment, the adult content detection algorithm may merely use queries and picks from co-occurrence data of a session when determining which images to remove from the fetched images. Likewise, in an embodiment, the adult content detection algorithm may use most or all of the previously tracked queries that were tagged as potentially adult content in nature that are stored in the full database when determining which images to remove from the fetched images. For example, in a session of queries q_1 . . . q_N, queries q_5, and q_8, were classified as pornographic queries. The image results that are tagged as adult content from those two queries may be used to filter the set of images returned to a clean query under consideration in the same session.

In block 216, the adult content detection algorithm stores in the database the statistically tracked query association information including the tagging information, the query-to-pick correlations, the pick-to-pick correlations, the query-to-query correlations, the pick-to-query correlations, as well as other similar statistically tracked user behavior correlations. The search engine may store other information regarding the user, other information regarding the images, etc. in the database as well.

In block 218, the search engine generates a different set of images that are returned in response to the user's query, then for a clean query, if search terms in the user's query indicate that the user is actually searching for adult content images. The search engine renders all of the returned images to the user's query. In one form, the search engine renders all of the returned images to the user's query by displaying a list of URL where the desired images exist and renders the images including thumbnails when the user accesses that URL.

Overall, the adult content detection algorithm may detect adult content images or other adult content by query association to improve a query for a picture search. The adult content detection algorithm may eliminate adult content images from the pictures that are returned in response to a user's query by identifying whether an image is adult content or not without doing image analysis.

In an embodiment, the search engine may statistically track user behavior with the database in the following manner. The search engine uses the stored content with one or more, current and/or previous, user queries to affect a current user's query based upon a correlation of user activity and/or user information obtained during a search session with similar information of other users. Thus, the user activity and/or user information of multiple users, during the same or previous search sessions, may be correlated with queries to effect an evolving association between queries and the organization and presentation of documents. The search engine may employ the database's ability to store users' activity over entire search sessions, thus, making possible the correlation of a number of different types of user activity and user information. The use of correlated user input allows such systems to provide relevant search results without the limitations imposed by merely key-word-based systems.

The search engine relies upon the received responses from multiple users for the purpose of correlation because independent users have made the same statistically significant associations. This correlation analysis includes the process of evaluating common actions, or information of multiple users, to identify statistically significant associations.

The search engine bases the correlation of a current user's query to current and or past user search engine (USE) activity and/or user information obtained during a search session with similar information of other users.

USE activity information and/or user information, during a search session, is recorded for several independent users. The USE activity may include the issuing of queries, the clicking of links on the search page leading to internal or external data, the clicking of links on subsequent internal pages leading to internal or external data, a return to the search page or any internal page subsequent to clicking an internal or external link, and other similar information. The USE activity may be continuous or occur within a practical duration period. That is, a time period may be specified that indicates termination of a search session. For example, if an interruption in recorded user activity exceeded a specified time, it may be practical to assume the search session was terminated. Subsequent user activity may be viewed as a new search session.

An association may be any pairing of queries, terms, concepts, articles or other web data, or combinations thereof, which may be made explicitly or implicitly by a user during a search session. A statistically significant association is an association that is probably not attributable to random occurrence. A correlation is recorded when a statistically significant association is made by two or more ostensibly independent users.

The database may store and maintain data files that maintain all USE activity information and user information in a table. The table has a data file that contains a number of data elements that record the queries for a number of users at various times and the URL (pick) that was selected (clicked) subsequent to each respective query for each respective user. Such a data file, may contain numerous other data elements representing USE activity information and/or user information. Such data elements, may represent, for example, the display rank of the result selected, the order the result was clicked by the user during the session, the user IP address, geo-location of the IP address, whether the image has previously been tagged as adult in nature, the number of sessions this image has been selected with other known images tagged as adult in nature, etc.

Exemplary correlations for various user responses may be described in more detail below.

A query-to-pick (Q2P) correlation associates a query with a pick. When multiple independent users make the same association that is a correlation candidate. The Q2P correlation may associate a query with all picks in a user session.

In general, the adult content detection algorithm may do a query-to-pick correlation and assign a property of the query to the pick. In this case, the adult content detection algorithm assigns the ‘adultness’ property of the query to the image of the pick. Essentially, this entails property inheritance from a known repository to an unknown. The adult content detection algorithm can determine if a user does a query search that is classified as adult content, the frequently clicked images should be classified as adult content (Q2P).

With Q2P, all picks recorded during a user session may be associated with a given query issued during that user session. A score may be assigned to each association, based upon various factors, including the time between query and pick, the number of intervening queries and/or picks, and the order of queries with respect to picks.

In addition, each association's score can be adjusted, based upon well-known factors, including rank of the pick in the result list at the time of association, duration of the pick (interval until next known user action), age or order of the association (relative to older or newer associations), and age of the first known instance of association.

Each user session can be of infinite duration. In different embodiments, a reasonable time limit, or limit on intervening actions, may be imposed beyond which no relationship between picks and queries will be assigned. For example, an interruption of sufficient duration can indicate a break in sessions.

A pick-to-pick (P2P) correlation associates all picks issued during a user session with all other picks issued during that session. In accordance with various embodiments, a score may be assigned to each association based upon various factors, including the time between picks, the number of intervening queries and/or picks, age or order of the association (relative to older or newer associations), and the pair-wise order of the associated picks, among others.

The adult content detection algorithm can associate that images that are often picked in conjunction with images reliably classified as adult images should themselves be tagged and classified as adult (P2P).

Other non-image analysis detection methods are possible such as 1) a pick-to-query (P2Q) correlation, 2) a query-to-query (Q2Q) correlation, 3) examining the source of the image, 4) examining non-image attributes of the image, or 5) a similar method. Further, inter-correlations between all of the stored categories of correlation information may also be made to help determine the adult nature of an image.

A pick-to-query (P2Q) correlation associates all queries recorded during a user session with a given pick issued during that user session.

A query-to-query (Q2Q) correlation associates all queries issued during a user session with all other queries issued during that session. The correlation associates all queries issued during a user session with all other queries issued during that session. For one embodiment, a query-to-query (Q2Q) score may be assigned to each association based upon various factors, including the time between queries, the number of intervening queries and/or picks, age or order of the association (relative to older or newer associations), whether or not the query results generated picks, and the pair-wise order of the associated queries, among others.

Determining if the query results generated picks, as well as the pair-wise order of the associated queries, can be particularly informative, as they can indicate whether one query is a “correction” of another. For any practical application, it is useful to know which of two associated queries is an error, and which, a correction.

The adult content detection algorithm may also determine the language of a Universal Resource Location and compare that language to the language of the query to determine if an adult content should be returned for the query. The text around an image may be examined to determine if the image should be classified as adult content in nature. The adult content detection algorithm may determine the language of a user based on IP and assign that language to a query often called from that country or a URL often visited. The adult content detection algorithm may determine the reading level of the user based on, for example, a web page specifically for young children, vocabulary of the query, or other means. The adult content detection algorithm may determine the location associated with a URL if most of the users who click on that URL are from the same general location. Images that come from a web page classified as an adult web page may be reliably classified as suspected adult images.

In one embodiment, the software used to determine adult images by query association can be embodied onto a machine-readable medium. A machine-readable medium includes any mechanism that provides (e.g., stores and/or transmits) information in a form readable by a machine (e.g., a computer). For example, a machine-readable medium includes read only memory (ROM); random access memory (RAM); magnetic disk storage media; optical storage media; flash memory devices; DVD's, electrical, optical, acoustical or other form of propagated signals (e.g., carrier waves, infrared signals, digital signals, EPROMs, EEPROMs, FLASH, magnetic or optical cards, or any type of media suitable for storing electronic instructions). Slower mediums could be cached to a faster, more practical, medium.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm may be generally conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the actions and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

While some specific embodiments of the invention have been shown the invention is not to be limited to these embodiments. For example, as discussed above, the adult content detection algorithm may check in the entire query database for all queries indicated as pornographic. As an alternative, the adult content detection algorithm may use the database to store information about images indicated as clean. The adult content detection algorithm still detects adult content images by tracked query association. However, adult content detection algorithm may assume that all images returned to a clean query may be potentially adult content in nature and merely returns the images indicated as clean in the database.

Thus, while certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

1. A machine readable storage medium containing instructions, which when executed by the machine, to cause the following operations, comprising:
detecting adult content images by tracked query association to a user's query for an image search; and
returning a set of images in response to the user's query on a search engine based on whether one or more images in the set are classified as an adult content image.

2. The machine readable storage medium containing instructions of claim 1, which when executed by the machine, to cause the further operation, comprising:
eliminating one or more adult content images from the set of images that are returned in response to the user's query by assuming that the user's query is seeking images non-pornographic in nature.

3. The machine readable storage medium containing instructions of claim 2, which when executed by the machine, to cause the further operation, comprising:
generating a second set of images that are returned in response to the user's query if search terms in the user's query indicate that a user is actually searching for adult content images.

4. The machine-readable storage medium containing instructions of claim 1, wherein the tracked query associations are made based upon statistically tracked user behavior.

5. The machine-readable storage medium containing instructions of claim 4, wherein the statistically tracked user behavior is selected from a group consisting of a pick-to-pick correlation, a query-to-pick correlation, a query-to-query correlation, or a pick-to-query correlation.

6. The machine-readable storage medium containing instructions of claim 4, wherein the tracked query associations are also made based upon tracked characteristics of a source of the image.

7. The machine-readable storage medium containing instructions of claim 1, containing instructions to cause the further operations, comprising:
tagging one or more images returned from a search result in response to an adult content query as potentially adult content images.

8. The machine readable storage medium containing instructions of claim 1, which when executed by the machine, to cause the further operation, comprising:
comparing images returned in response to the user's query to information regarding an adult content nature of the images, wherein the information regarding the adult content nature of the images may be determined by the tracked query association information.

9. A computing apparatus, comprising:
means for detecting adult content images by tracked query association to a user's query for an image search; and
means for returning a set of images in response to the user's query based on whether one or more images in the set are classified as an adult content image.

10. The apparatus of claim 9, further comprising:
means for comparing images returned in response to the user's query to information regarding an adult content nature of the images that is stored in a database, wherein the information regarding the adult content nature of images may be determined by the tracked query association information.

11. The apparatus of claim 10, wherein the tracked query association is made based upon statistically tracked user behavior.

12. A method, comprising:
detecting adult content images by tracked query association to a user's query for an image search; and
returning a set of images in response to the user's query on a search engine web page based on whether one or more images in the set are classified as an adult content image.

13. The method of claim 12, further comprising:
eliminating one or more adult content images from the set of images that are returned in response to the user's query by assuming that the user's query is seeking images non-pornographic in nature.

14. The method of claim 12, further comprising:
comparing images returned in response to the user's query to information regarding an adult content nature of the images, wherein the information regarding the adult content nature of images may be determined by statistically tracked user behavior and tracked characteristics of a source of the image.

15. The method of claim 12, further comprising:
tagging one or more images returned from a search result in response to an adult content query as potentially adult content images.

16. A computing system, comprising:
a server to present a web page having a search engine, wherein the search engine to allow users to submit a user's query to search for images relevant to search terms in the user's query, and the server to implement an algorithm to detect adult content images by tracked query association to the user's query, wherein the algorithm to return a set of images in response to the user's query on the search engine based on whether one or more images in the set are classified as an adult content image; and
a database to store potential adult content information regarding one or more images potentially in the set of images based upon the tracked query association information.

17. The system of claim 16, wherein the algorithm to determine if the user's query is searching for adult images by search terms in the user's query.

18. The system of claim 16, wherein the algorithm to compare the images in the set of images to tracked information stored in the database about any previously returned images from known pornographic queries.

19. The system of claim 16, wherein the algorithm to tag one or more images returned from a search result in response to an adult content query as potentially adult content images, and the database to store information regarding the tagging of the one or more images.

20. The system of claim 16, wherein the algorithm to also detect adult content images based upon tracked characteristics of a source of the image.
